(19) United States
(12) Patent Application Publication
(10) Pub. No.: US 2026/0160227 A1
(43) Pub. Date: Jun. 11, 2026

(54) CIRCULAR CLOSED-LOOP TURBINE TUNNEL MECHANISM

(71) Applicant: William Edward Casey, Sequim, WA (US)

(72) Inventor: William Edward Casey, Sequim, WA (US)

(21) Appl. No.: 19/179,889

(22) Filed: Apr. 15, 2025

Related U.S. Application Data
(60) Provisional application No. 63/648,927, filed on May 17, 2024.

(51) Int. Cl. F03D 1/04; H02K 7/18

(52) U.S. Cl. CPC F03D 1/04; F03D 1/046; H02K 7/183

(57) ABSTRACT

An energy generation system featuring a circular-shaped, closed-loop passageway equipped with internally driven airflow and turbine mechanisms. Airflow is generated by an impeller powered by an external energy source, circulating within the tunnel to drive turbines embedded in its walls. The turbines'obverse blades are exposed to airflow for energy generation, while their reverse blades are shielded to reduce drag. The invention delivers energy with the potential to magnify power output relative to input.

### CROSS-REFERENCE TO RELATED APPLICATIONS

This application is based upon U.S. Provisional Ser. No. 63/648,927, entitled CIRCULAR CLOSED-LOOP TURBINE TUNNEL MECHANISM, filed 17 May 2024, naming William Edward Casey as inventor. The entirety of such provisional patent application is incorporated by reference herein.

### STATEMENT REGARDING FEDERALLY SPONSORED RESEARCH OR DEVELOPMENT

Not Applicable.

### REFERENCE TO A MICROFICHE APPENDIX

Not Applicable.

### REFERENCE PUBLICATIONS

U.S. Pat. No. 5,452,609, Bouis; Xavier, Sep. 26, 1995
U.S. Pat. No. 11,920,555, Kuninori TSUDA, Mar. 5, 2024
U.S. Pat. No. 11,434,870, Suma; Alexander Boudewijn, et al, Sep. 6, 2022
U.S. Pat. No. 11,131,292, Satou; Akinori, Sep. 28, 2021
U.S. Pat. No. 9,670,903, Tanguchi; Hayato, Jun. 6, 2017

### FIELD OF THE INVENTION

The present invention relates to a novel energy generation system using an innovative turbine enclosure arrangement. The invention features a circular-shaped, closed-loop passageway equipped with internally driven airflow and turbine mechanisms. Airflow is generated by an impeller powered by an external energy source, circulating within the tunnel to drive turbines embedded in its walls. The turbines'obverse blades are exposed to airflow for energy generation, while their reverse blades are shielded to reduce drag. The invention delivers energy with the potential to magnify power output relative to input.

### DESCRIPTION OF PRIOR ART

Wind tunnels have been pivotal in the advancement of aerodynamics, engineering, and various scientific disciplines. While their functionality has contributed to many achievements, there has been insufficient use of wind tunnels for energy production.

The concept of wind tunnels dates back centuries, with early experiments conducted by Leonardo da Vinci in the 15th century. However, significant advancements began in the 19th century with the work of Sir George Cayley, who designed rudimentary wind tunnels to study air flow over different shapes.

The first operational wind tunnel was built by the Wright brothers in 1901 to test their aircraft designs. This wind tunnel featured a simple open-ended design and provided valuable insights into aerodynamics, contributing to the success of the Wright Flyer in 1903. Throughout the 20th century, significant advancements were made in wind tunnel design, including closed-loop tunnels to recirculate air, improved control mechanisms, and more sophisticated instrumentation for data collection.

Wind tunnels have found applications across diverse industries, including aerospace, automotive, civil engineering, and sports. In aerospace, wind tunnels are crucial for testing aircraft designs, optimizing aerodynamic performance, and improving fuel efficiency.

Wind tunnels have emerged as indispensable tools in the development and optimization of wind energy systems for power generation. The function of such tools for wind energy systems has been in the testing of turbine structures, aerodynamics, and blade designs. While wind tunnels serve their purpose for these applications, there has been no development or application of wind tunnels comparable to this invention's specification for the purpose of generating power.

Conventional wind tunnels play a pivotal role in the advancement of wind energy technology by providing valuable insights into aerodynamic behavior, design optimization, and performance validation of wind turbines. Although wind tunnels have played such significant roles, this invention introduces an innovative method of utilizing closed-loop circular wind tunnels employing a unique air flow system and efficient turbine shielding to harness the proficiency of turbines for power generation.

There are existing wind tunnel energy generators that revolve around an enclosed or semi-enclosed structure, resembling a tunnel. Air mover systems are used to generate wind with these prior art devices and can be strategically placed either at the entry or throughout the open tunnel structure to ensure consistent wind velocity and direction. In contrast to this prior art, this invention does not have an open entry point for the air mover systems since this specification describes a unique closed-loop tunnel passageway with an air moving system impeller mechanism embedded in the passageway.

It is noted that prior art wind tunnel energy generators can be designed to augment natural wind flows. In contrast, this invention does not incorporate natural wind flows and relies on the embedded air moving system impeller mechanism for air flow movement within the closed-loop passageway.

All prior art wind tunnels and turbines are related to the testing of turbines and such other turbine components in wind tunnels, but there is no application of turbines being installed and shielded in the walls of prior art wind tunnels. Any combination of wind tunnels and turbines in prior art occurs with wind being directed and sent down a straight tunnel of open-ends with a turbine at the output end of the air flow.

This novel closed-loop wind tunnel energy generator invention is the result of the inventor's earlier research into and design of wind shield-vanes for VAWTs. The innovative system structure described in this specification provides the opportunity for cleaner energy production, energy storage that allows for a continuous power supply, and sustainability.

The invention references several key examples of prior art to highlight its novelty and improvement over existing technologies. Here are examples of relevant prior art:
1. Traditional Wind Tunnels
Open-Ended Wind Tunnels: Developed historically for aerodynamics testing (e.g., Wright brothers'1901 wind tunnel), these designs lack the closed-loop mechanism and are primarily used for testing airflow around objects rather than energy generation.
Closed-Loop Wind Tunnels: Modern advancements feature air recirculation but are designed for testing, not for integrating turbines for power production.
2. Wind Tunnel Energy Generators
Prior art includes systems that incorporate turbines within open or semi-enclosed tunnels to enhance natural wind flows or create artificial airflow using fans. However, these systems:
   Have open-ended designs that rely on external wind or open airflow.
   Do not utilize a closed-loop design or turbine shielding mechanisms to optimize energy efficiency.
3. Vertical Axis Wind Turbines (VAWTs)
Turbines like cylindrical or oblong VAWTs capture wind efficiently but are generally installed in open environments. Prior systems do not embed or shield turbines within a closed-loop tunnel to reduce drag and enhance efficiency.
4. Air-Moving Systems
Airflow systems, such as axial compressors or inline duct fans, have been used in HVAC systems or aerodynamics testing. However, they have not been combined with turbines in a closed-loop structure for the purpose of generating energy.
5. Energy Generation Systems
Traditional wind energy systems rely on large horizontal axis wind turbines (HAWTs) exposed to natural wind. These systems lack the controlled environment provided by the closed-loop tunnel, which allows for consistent airflow and energy output.
6. Shielding Mechanisms for Turbines
Concepts or patents related to turbine blade shielding or designs to reduce drag, but generally in open systems or with natural wind flows.

### Key Differences Highlighted by the Invention:

Closed-Loop Airflow System: Eliminates reliance on natural wind and open environments, distinguishing it from existing wind tunnel or turbine technologies.
Independent Airflow Generation: The use of an air-moving system to independently drive airflow distinguishes this invention from prior reliance on natural or external air sources.
Turbine Placement and Shielding: Embedding turbines in the tunnel walls and shielding reverse blades for efficiency is unique to this invention.
Energy Magnification: Potential of exceeding input-to-output energy ratios, attributed to the system's innovative use of controlled airflow dynamics.

By addressing the limitations of prior systems, this invention introduces a groundbreaking approach that uniquely integrates elements of wind tunnels, turbine systems, and airflow mechanics to create a novel configuration. By combining these features in a novel and unobvious manner, the invention establishes itself as distinct from prior art and introduces a unique approach to efficient, clean energy generation.

### New Art

What is claimed is a unique and novel closed-loop mechanism to provide and improve power generation from wind turbines. This invention uses an innovative circular closed-loop turbine tunnel design and employs one or more embedded and encapsulated turbine structure with shielding, and a control air moving system impeller mechanism to provide optimization of air flow conditions within the passageway housing.

The invention mechanism consists of a closed-loop tunnel passageway, one or more air moving system impeller mechanism being connected to an external power supply and incorporated within the closed-loop tunnel passageway, and built-in one or more turbine structure affixed to the wall of the closed-loop tunnel passageway with shielding of reverse blade exposure.

This circular closed-loop turbine tunnel uses a torus design of varying dimensional extents with one or more air moving system and one or more exposed and encapsulated turbine structure, with the air flow activated turbine output shaft drive force connected to one or more electrical or mechanical power producing device that is then directed to storage systems or power-driven apparatuses.

The structure of the passageway may be constructed in various shapes, as example and not limitation, circular, rectangular, square, oblong, half-circle with a flat side, such shape design selection dependent on the style of turbine structure to be employed. The closed-loop tunnel passageway is equipped with velocity, pressure, directional baffles, induction, purge, and thermal management and control devices.

The circular closed-loop turbine tunnel construction employs: a circular ring housing of varying dimensions to suit a desired application purpose as a passageway; an air moving system with impeller mechanism located within the passageway; the impeller mechanism engaged to produce an air velocity and pressure within the passageway; and, one or more turbine structure located and encapsulated in the wall of the passageway. The impeller mechanism produces the action of air velocity and pressure within the passageway which creates a force to impact the turbine structure blades causing the turbine to spin. The turbine structure blades being connected to a mounting shaft, and the mounting shaft further connected to a power generating device capable of, as example, producing electric current or mechanical force. The produced power can be stored in energy storage systems (e.g., battery) or transferred and conveyed to supplemental mechanisms.

The air moving system impeller mechanism comprises, as example and not limitation, a fan and motor assembly that produces a wind velocity and pressure within the circular closed-loop tunnel passageway. Various air moving systems of current or future developed designs may be employed in the operation of this invention, as example a jet engine. One or more air moving system impeller mechanisms may be employed in the invention design. The air moving system impeller mechanism may be of any design and structure that produces an air flow, for example, an axial flow compressor.

The closed-loop tunnel passageway may include in the housing air flow directional baffles. Such air flow directional baffles being constructed to employ aerodynamic features, as example Bernoulli Effect, to improve air flow velocity and pressure to modify the impact force on the turbine blades

The source of power driving the impeller mechanism originates from a separate external energy source. As example, an axial flow compressor may use an electric motor or conventional engine, each as being supplied with electricity or appropriate fuel. Other types of air moving systems may include inline duct fan air blower devices with similar external energy source.

This invention employs turbine structures, as example and not limitation, consisting of cylindrical, cubical, oblong, or spherical vertical axis wind turbine structures, with such turbine structure employing any form of wind capture mechanism (e.g., blade, cup, groove, channel). The one or more turbine structure being installed at various positions on the circular closed-loop tunnel passageway wall and mounted in an apparent mid-point position to the passageway wall such that the obverse half of the turbine blades (i.e., power stroke) are within the passageway wall, and the reverse half of the turbine blades (i.e., returning stroke) are external to the passageway wall in a shielded configuration. The optimal positioning of turbine structures, as displayed in the listing of attached Figures, will be calculated to provide highest efficiency of turbine operation. The turbine blade shielding feature functions to allow wind to impact the obverse side of the turbine blade while reducing or preventing the negative effect of impacting wind current and drag on the returning reverse rotation turbine blades.

This innovative turbine placement and shielding mechanism provides for the open blade wind power capture obverse portion of the turbine blade structure to achieve greater productivity (i.e., rotational efficiency) and mechanical advantage since the opposition/negative force of wind current on the returning reverse rotation portion of the turbine blade structure is essentially eliminated.

The turbine structure will have its blades being connected to a shaft transfer, and the shaft transfer further connected to a device capable of producing power, as example, electric current or mechanical force.

In an example of the turbine shaft being connected to a DC generator, the output of the generator to a battery consists of negligible or no load to the rotation of the turbine blades and shaft transfer. In this example, there is insignificant frictional or mechanical impediment to the rotation of the turbine blades being caused by the DC generator action. With consideration of thermodynamic theories, a conventional energy balance theory does not necessarily comport with this invention, since a component from the natural world has been added to the energy balance equation, i.e., air as a balancing untethered and freed power.

In this closed-loop passageway system, the energy from an external source (e.g., electricity, fuel) is converted into a mechanical force (e.g., impeller rotation) which is then converted into a natural force (e.g., air motion, velocity, pressure) which is then converted back into mechanical force (e.g., turbine blade rotation) that is then converted into energy (e.g., a turbine shaft attached to a kinetic transmission apparatus, generator, or alternator as output) and stored in a power storage system (e.g., battery), conveyed to an energy grid, or connected to any of mechanical devices (e.g., gear-driven mechanisms).

As example, should this invention be installed with an air moving system impeller mechanism producing sufficient wind velocity and pressure in the closed-loop passageway to spin three turbine structures within the passageway with each connected to a 200 watt generator, the result would be a generating capacity for a total of approximately 600 watts.

It is the inclusion of wind force and no-load energy generation that accounts for this novel effect. The design and operation of this invention as described in this specification allows for such innovative results.

One skilled in the art and science of mechanical device fabrication would readily understand the technical procedures necessary to construct this invention and related processing operations.

Accordingly, having expressed the present invention by way of description, example, and with reference to the attached drawing Figures, it will be appreciated that changes and modifications may be made in the form and steps to the invention and any of the exemplary design and operational embodiments shown and described herein without departing from the spirit, applications, implications, or scope of the invention which is defined and presented in this specification.

### Outline of Operation

The invention is a Circular Closed-Loop Turbine Tunnel Mechanism designed to enhance power generation efficiency by utilizing a self-contained, continuous airflow system. The system comprises a circular-shaped closed-loop passageway with one or more turbine structures embedded within its walls and an air-moving impeller mechanism. Key features include:

Innovative Airflow System: The closed-loop design eliminates reliance on external natural wind flows, with airflow entirely generated and managed internally by an impeller mechanism powered by an external energy source.

Turbine Placement and Shielding: Turbines are strategically installed within the tunnel walls, with the obverse blades exposed to airflow for power generation and reverse blades shielded to minimize drag, improving rotational efficiency.
1. Energy Efficiency and Magnification: By recycling airflow within the system, the invention maximizes power output relative to energy input, potentially surpassing the input-to-output energy ratios through the incorporation of untethered air motion as a dynamic force.
2. Modular and Scalable Design: The structure can be adapted for various applications, from small-scale installations to large industrial structures, and supports energy storage solutions like batteries or direct transfer to external devices.

This mechanism introduces a novel approach to clean and sustainable energy generation, leveraging advanced aerodynamic principles for optimized performance.

The primary objective of the invention is to provide a circular closed-loop turbine tunnel mechanism that optimizes energy generation by leveraging a self-contained airflow system to drive turbines embedded within its structure. The invention objectives are to:
1. Enhance Power Efficiency: Maximize energy output relative to input by creating a controlled, continuous airflow within a closed-loop passageway, minimizing energy losses and drag.
2. Enable Clean and Sustainable Energy Generation: Offer a scalable solution for generating renewable energy without relying on natural wind flows, ensuring consistent and predictable power production.
3. Introduce Advanced Turbine Design: Improve turbine efficiency through innovative placement and shielding mechanisms that reduce drag and optimize rotational force.
4. Support Energy Storage and Distribution: Facilitate the conversion of mechanical energy into electrical or mechanical power, which can be stored in batteries or used directly by external devices of any configuration or operating system.
5. Provide Scalability and Adaptability: Allow for customization of the system's components, dimensions, and configurations to suit various applications, from small-scale use to industrial energy production.

The invention seeks to revolutionize traditional energy generation systems with innovative turbine integration.

### DESCRIPTION OF THE DRAWINGS

These and other advantages of this novel and innovative invention mechanism will become more apparent from the detailed description of the various embodiments of the present specification with reference to the drawings wherein:

FIG. 1. Illustrates a schematic and diagram of the design structure of the circular closed-loop turbine tunnel structure in accordance with the embodiments of the present specification.

FIG. 2. Illustrates a schematic and diagram of the design structure of the turbine placement and shielding of the turbine along the wall of the passageway in accordance with the embodiments of the present specification.

FIG. 3. Illustrates a schematic and diagram of the design structure of the installed turbine with an air flow process and generating attachment in accordance with the embodiments of the present specification.

FIG. 4. Illustrates a schematic and diagram of the design structure of the circular closed-loop turbine tunnel structure and placement of the air moving system impeller mechanism in accordance with the embodiments of the present specification.

FIG. 5. Illustrates examples of air moving systems in placement and operation in accordance with the embodiments of the present specification.

### DETAILED DESCRIPTION AND MODE OF IMPLEMENTATION

The present specification and invention provides the ability to improve the power generation efficiency of a turbine mechanism by employing a manufactured wind current in a tunnel arrangement to magnify power output compared to power input. No inferences should be drawn that the design structures (logically or physically) as described or displayed are intended to limit the invention's dimensional design structure that is, or may be, implemented based on user application.

The embodiments of the present specification pertain to an invention that is designed for individual, commercial, and industrial applications. The embodiments provide a structure for improving turbine power efficiency involving the magnification of power output compared to power input.

The following presents the general operation of the present invention with processing and construction features that may be accomplished by a person skilled in the art of mechanical fabrication and related system infrastructures.

A first determination is made as to the dimensions of the turbine structure mechanism to be employed. Relevant specifications would include, as example and not limitation, shape, overall circumference, tunnel passage height, tunnel passage width, number of turbines. For this example, and not limitation, a cylindrical turbine arrangement such as a vertical axis wind turbine with a center axis supporting structure will be employed for illustrative purposes and display. Other turbine structures may be used and such employment of various turbines will determine the design shape of the tunnel passageway. The dimensions of all invention components may range, as appropriate, from microns to multi meters based on user configuration options.

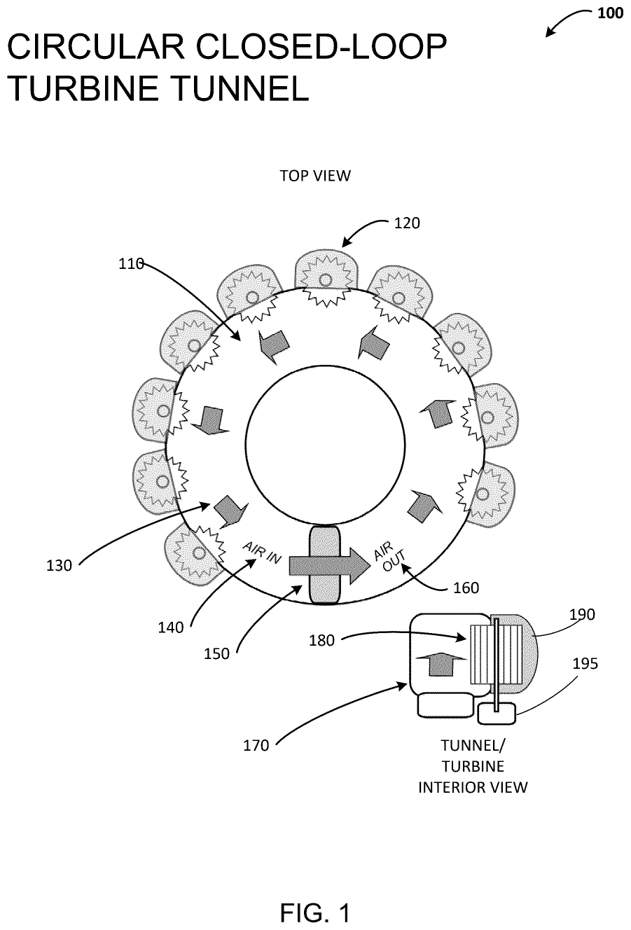

FIG. 1 displays the components of the closed-loop turbine tunnel structure assembly. The number and placement of turbine structures is illustrative as example and not as definitive arrangement.

Components in FIG. 1 include the complete device 100: the tunnel passageway 110; the turbine structure and mounting position 120; the air flow direction 130; the air input for the air moving system impeller mechanism 140; air moving system impeller mechanism 150; the air output for the air moving system impeller mechanism 160; the tunnel passageway housing 170; the turbine structure obverse blades extended into the tunnel passageway wall 180; the turbine structure reverse blades encapsulated with a shielding mechanism outside the tunnel passageway wall 190; and, a power conversion device attached to the transfer shaft of the turbine structure 195.

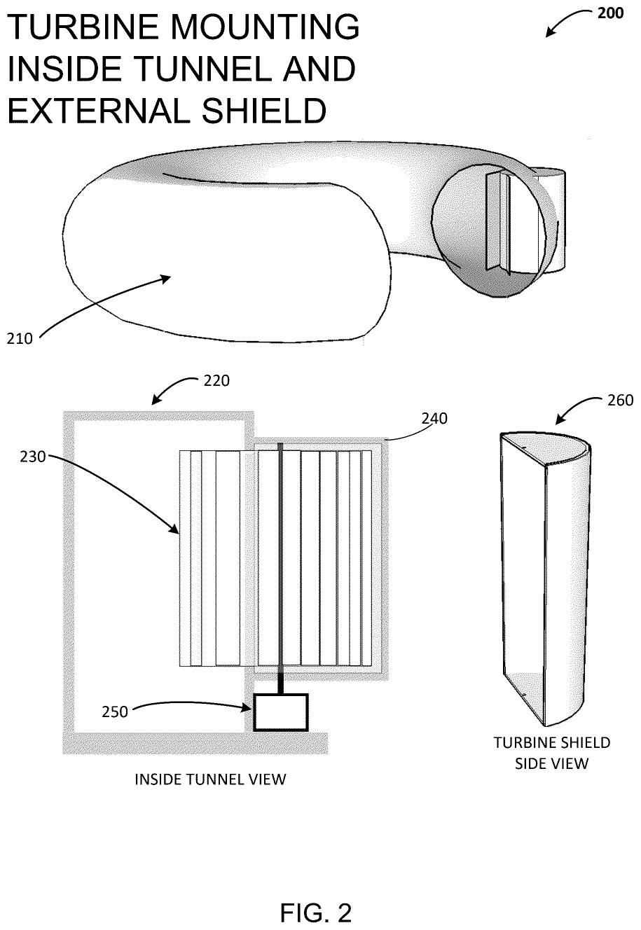

FIG. 2 displays a cutout of the tunnel passageway to reveal the placement of one or more turbine structure with an example of the external shielding. The number and placement of turbine structures is illustrative as example and not as definitive or limiting arrangement.

Components in FIG. 2 include a representation of the tunnel passageway and turbine placement 200: the tunnel housing 210; an alternate tunnel housing design 220; the turbine structure obverse blades within the passageway for power stroke 230; the turbine structure reverse blades encapsulated with a shielding mechanism outside the tunnel passageway wall 240; a power conversion device attached to the transfer shaft of the turbine structure 250; and, a shielding mechanism, as example and not limitation, for encapsulating the turbine structure reverse blades 260.

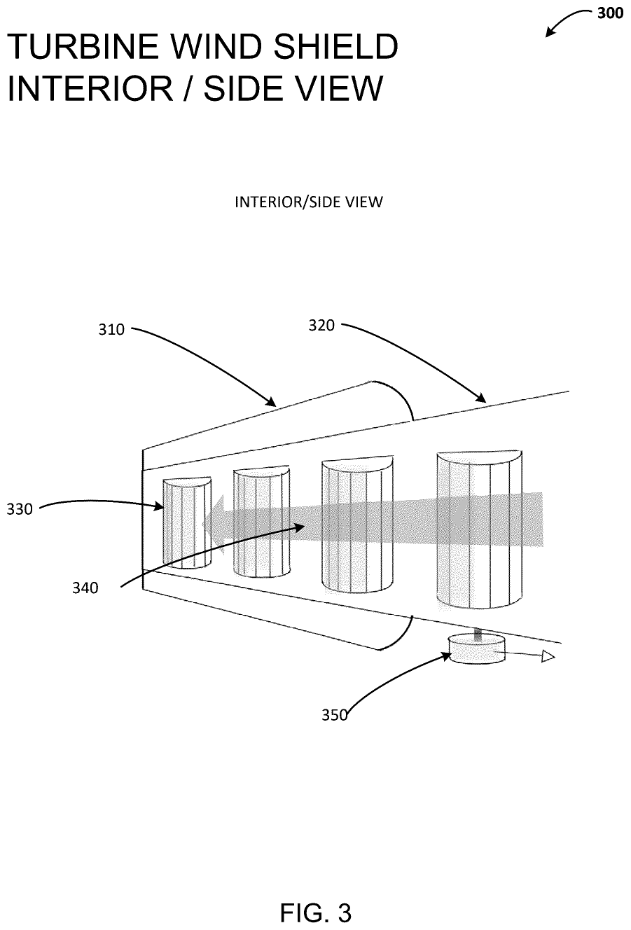

FIG. 3 displays an interior cutaway view of the placement of turbine structures along the inside wall of the tunnel housing with air flow. The number and placement of turbine structures is illustrative as example and not as definitive or limiting arrangement.

Components in FIG. 3 include a representation of the tunnel passageway and turbine placement with air flow 300: the exterior shielding mechanism encapsulating the turbine structure reverse blades 310; the wall of the tunnel housing 320; the turbine structure obverse blades exposed to the air flow 330; the air flow direction and velocity impacting the exposed turbine structure obverse blades 340; and, a power conversion device attached to the transfer shaft of the turbine structure 350.

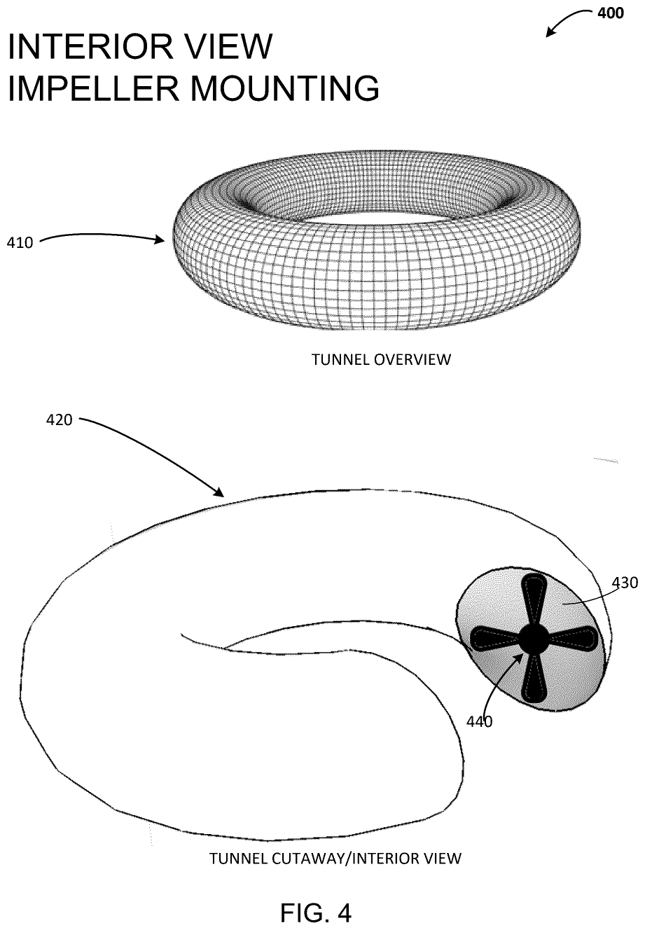

FIG. 4 displays a tunnel housing overview, as example, with placement of the air moving system impeller mechanism within the passageway. The number and placement of air moving system impeller mechanism is illustrative as example.

Components in FIG. 4 include a representation of the tunnel housing and air moving system impeller mechanism with placement within the passageway 400: a closed-loop tunnel as example 410; a cutaway view of the tunnel housing 420; the interior of the tunnel passageway 430; and, placement of the air moving system impeller mechanism within the tunnel passageway 440.

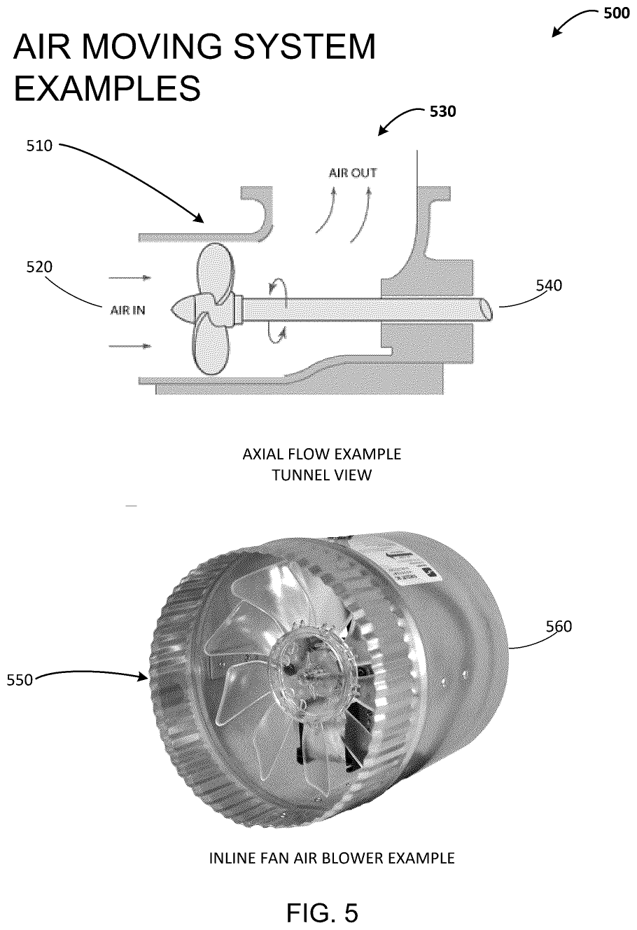

FIG. 5 displays, as example and not limitation, an air moving system impeller mechanism, with placement, as example, within the closed-loop tunnel passageway. The number and placement of air moving system impeller mechanism is illustrative as example. Components in FIG. 5 include a representative example of air moving systems and impeller mechanisms (e.g., axial flow compressor, inline air blower) with placement within the invention design 500; the exterior wall of the housing passageway 510; the air input to the impeller mechanism 520; the air velocity and pressure output 530; the impeller mechanism and drive shaft connected to an external engine or mechanism forcing the rotation of the drive shaft 540; the inline placement of an air moving system housing 550; and, the air moving system connected to an external power source 560.

What is claimed is:

1. A circular closed-loop turbine tunnel mechanism for generating energy, comprising:
a. a closed-loop passageway constructed in a toroidal shape to house a continuous airflow;
b. at least one air-moving system with an impeller mechanism located within the passageway wherein configured to circulate air within the passageway and operable to produce airflow with controlled velocity and pressure within the passageway, said system powered by an external energy source;
c. one or more turbine structure installed within the walls of the passageway, wherein the turbine structure comprises obverse blades exposed to the airflow within the passageway for power generation and reverse blades shielded to reduce drag; and,
d. a power conversion transfer mechanism device operatively connected to the turbine structure to convert mechanical energy into electrical or mechanical power.

2. The mechanism as claimed in claim 1, wherein the shielding for the reverse turbine blades is configured to minimize resistance and enhance the rotational efficiency of the turbine.

3. The mechanism as claimed in claim 1, wherein the closed-loop passageway further includes airflow directional baffles with management systems to maintain optimal operating conditions within the passageway to regulate and optimize air velocity and pressure for improved turbine structure performance using aerodynamic efficiency principles including the Bernoulli effect.

4. The mechanism as claimed in claim 1, wherein the air-moving impeller mechanism, having variable speed and pressure controls to adjust airflow conditions based on operational requirements, is selected from the group consisting of axial flow compressors, inline duct fans, or other air-moving devices capable of producing sufficient airflow velocity and pressure.

5. The mechanism as claimed in claim 1, wherein the turbine structure-attached shaft power conversion device is selected from the group consisting of direct current (DC) generators, alternators, or mechanical drives.

6. The mechanism as claimed in claim 1, wherein the turbine structure is selected from vertical axis wind turbines with configurations including cylindrical, cubical, oblong, or spherical shapes and having:
a. blades with a geometry optimized for efficient interaction with airflow having features such as grooves, channels, or cups to maximize wind capture;
b. shielding mechanisms on the reverse blade side to minimize drag and enhance rotational efficiency; and,
c. a mounting system that securely positions the turbine structure within the passageway walls calculated to align the turbine blades in an optimal position between obverse blade exposure and reverse blade shielding.

7. The mechanism as claimed in claim 1, wherein the closed-loop passageway is constructed from materials suitable for thermal and mechanical stress management, including metals, composites, or polymers.

8. The mechanism as claimed in claim 1, wherein the power output from the turbine structure-attached power conversion device is delivered to an energy grid, stored in an energy storage system, or mechanically transferred to one or more external device for use.

9. The mechanism as claimed in claim 1, further comprising a control system to monitor and regulate airflow velocity, pressure, turbine speed, turbine performance, and power output to adjust the impeller mechanism manually or dynamically.

10. A method of generating energy using a circular closed-loop turbine tunnel mechanism, wherein comprising:
a. driving an air-moving system impeller mechanism to create controlled airflow within a closed-loop circular toroidal passageway using an impeller mechanism powered by an external energy source;
b. directing the airflow over turbine blades positioned within the passageway walls;
c. positioning the turbine obverse blades in a passageway system for maximum exposure to airflow;
d. shielding the turbine reverse blades in a passageway system to minimize aerodynamic drag;
e. exposing obverse turbine blades to the circulating airflow to generate mechanical energy while shielding reverse blades to minimize drag;
f. utilizing directional baffles to adjust airflow velocity and pressure for optimized turbine performance;
g. converting the mechanical rotational energy from the turbine structure into electrical or mechanical energy via a power conversion device; and
h. storing or transmitting the generated energy for external use.
